(19) United States
(12) Patent Application Publication
(10) Pub. No.: US 2008/0280019 A1
(43) Pub. Date: Nov. 13, 2008

(54) POWDERED HEALTH FOOD

(75) Inventor: Isao Ogaki, Toshima-ku (JP)

Correspondence Address: MERCHANT & GOULD PC, P.O. BOX 2903, MINNEAPOLIS, MN, 55402-0903, US

(73) Assignees: W.I. SYSTEM CO., LTD., Toshima-ku (JP); SAMS INC., Kiyose-shi (JP)

(21) Appl. No.: 12/044,455

(22) Filed: Mar. 7, 2008

(30) Foreign Application Priority Data
Apr. 11, 2006 (JP) 2006-108291
Mar. 7, 2007 (JP) 2007-57123

(51) Int. Cl. A23L 1/29

(52) U.S. Cl. 426/622; 426/615; 426/632; 426/629; 426/637

(57) ABSTRACT

A powdered health food contains at least one selected from a group consisting of powders of a plurality of vegetables. A Fischer ratio which is a molar ratio (BCAA/AAA) of a branched chain amino acid (BCAA) to an aromatic amino acid (ARA) contained in the powdered health food is 2.1 or higher.

### CROSS REFERENCE TO RELATED APPLICATIONS

This application claims the benefit of Japanese Patent Application No. 2006-108291 filed on Apr. 11, 2006, the disclosure of which is incorporated herein by reference.

### BACKGROUND OF THE INVENTION

1. Field of the Invention

The present invention relates to a powdered health food capable of improving or maintaining a hepatic function.

2. Description of the Related Art

In general, it is known that, when a hepatic function is lowered due to a hepatic disease, an amino acid concentration in blood changes compared to that in a normal state. Specifically, concentrations of branched chain amino acids (such as leucine, isoleucine, and valine) are decreased by being metabolized in a skeletal muscle or a brain. On the other hand, a concentration of an aromatic amino acid (such as phenylalanine and tyrosine) is increased because the aromatic amino acid is hardly metabolized in a dysfunctional liver. Since the concentration of the branched chain amino acid is decreased and the concentration of the aromatic amino acid is increased, a Fischer ratio which is a molar ratio of the branched chain amino acid to the aromatic amino acid is lowered.

If the Fischer ratio in blood is lowered, for example, an amount of glutamic acid produced from a branched chain amino acid is decreased. Thus, a metabolized amount of ammonia in a skeletal muscle is decreased, and a concentration of ammonia in blood is increased. Note that an amount of ammonia metabolized in a liver is naturally decreased, because the hepatic function is lowered. A psychoneurotic symptom (hepatic encephalopathy) such as a consciousness disorder may be caused, if ammonia at a relatively high concentration migrates from a cardiovascular system to a central nervous system.

A symptom of the hepatic encephalopathy can be improved by administering an infusion having a high Fischer ratio where a concentration of a branched chain amino acid is high and that of an aromatic amino acid is low, or by orally administering an amino acid formulation or a peptide mixture having a high Fischer ratio, to thereby improve the Fischer ratio in blood. As the amino acid formulation, Aminoleban (registered trademark) EN (Otsuka Pharmaceutical Factory, Inc.) and Hepan (registered trademark) ED (Ajinomoto Co., Inc.) and the like are known.

As the peptide mixture, for example, Japanese Laid-Open Patent Publication No. 2986764 (claim 1, Paragraphs 0014 to 0019) discloses a peptide mixture which is obtained by separately hydrolyzing a casein and a whey protein with enzymes, separately liberating and removing an aromatic amino acid and peptide moieties containing the aromatic amino acids, and subsequently mixing them.

In the above amino acid formulation and the peptide mixture, the concentration of an amino acid is controlled, or an aromatic amino acid is removed by chemical treatment. Thus, the formulation or the mixture obviously has a high Fischer ratio. However, the formulation and the mixture require high production costs and are thus expensive, and does not taste good because of bitterness inherent in an amino acid. Hence, it is not easy to ingest them on a daily basis. Further, a prescription by a doctor is required to administer Aminoleban (registered trademark) EN or Hepan (registered trademark) ED. They cannot be administered for a purpose of preventing a hepatic function from lowering.

Thus, the present invention has been made in an attempt to provide a powdered health food which can be manufactured at low cost, has a satisfactory taste preference and can improve or maintain a hepatic function by improving the Fischer ratio in blood.

### SUMMARY OF THE INVENTION

A powdered health food according to the present invention contains at least one selected from a group consisting of powders of a plurality of vegetables. A Fischer ratio which is a molar ratio of a branched chain amino acid to an aromatic amino acid contained in the powdered health food is 2.1 or higher.

The powdered health food contains a powder composed of a vegetable without degrading the vegetable into an amino acid or a peptide. Therefore, the powdered health food can be manufactured at low cost and has a satisfactory taste preference. The powdered health food has the Fischer ratio of 2.1 or higher and a satisfactory digestive absorbability due to its powdered form. Thus, a branched chain amino acid is effectively distributed throughout a body of a subject who takes the powdered health food, and the Fischer ratio in blood of the subject can be improved.

The above powdered health food further contains at least one selected from a group consisting of powders of grain, potato, beans, nuts and seeds, fruit, mushroom and alga.

By further containing at least one powder selected from the aforementioned group, the powdered health food enables to effectively ingest a nutritional component which is not or little contained in the vegetable.

The above grain and potato include respective processed products thereof.

The powdered health food including the processed products, in which most of the nutritional component is a carbohydrate or saccharide, makes it possible to ensure a sufficient amount of energy to be taken while suppressing an amount of a protein contained therein.

Other features and advantages of the present invention will become more apparent from the following detailed description of the invention, when taken in conjunction with the accompanying exemplary drawings.

### BRIEF DESCRIPTION OF THE DRAWINGS

FIG. 1 is an appearance side view of a pulverizer used in an example of a method of manufacturing a powdered health food according to an embodiment of the present invention.

FIG. 2 is a magnified sectional view around a pulverizing chamber of the pulverizer used in the example of the method of manufacturing the powdered health food according to the embodiment of the present invention.

FIG. 3A is a sectional view when cut along the line A-A in FIG. 2. FIG. 3B is a sectional view when cut along the line B-B in FIG. 2.

FIG. 4 is a front view of a rotary wing on a charging side (or a rotary wing on a discharging side) of the pulverizer used in an example of the method of manufacturing the powdered health food according to the embodiment of the present invention.

FIG. 5 is a schematic view for explaining a portal-systemic shunt model dog used in an administration study.

FIG. 6A to FIG. 6B are graphs showing changes in states of test dogs in the administration study.

FIG. 7A is a graph showing changes in branched chain amino acid concentrations in plasma in the test dogs in an administration study. FIG. 7B is a graph showing changes in tyrosine concentrations in plasma in the test dogs in the administration study.

FIG. 8A is a graph showing changes of albumin concentrations in serum in the test dogs in the administration study. FIG. 8B is a graph showing changes in total protein concentrations in serum in the test dogs in the administration study.

FIG. 9A is a graph showing changes in ammonia concentrations in blood in the test dogs in the administration study. FIG. 9B is a graph showing changes in zinc concentrations in serum in the test dogs in the administration study.

### DETAILED DESCRIPTION OF THE EXEMPLARY EMBODIMENT

An embodiment of the present invention is described below. Classification of food groups used herein is based on STANDARD TABLES OF FOOD COMPOSITION IN JAPAN Fifth Revised and Enlarged Edition (Jan. 24, 2005, Ministry of Education, Culture, Sports, Science and Technology, Council for Science and Technology, Resource Survey Task Force Report <http://www.mext.go.jp/b menu/shingi/gijyutu/gijyutu3/toushin/05031802.htm> (Searched on Jan. 23, 2007).

A powdered health food according to the embodiment contains at least one selected from a group consisting of powders of vegetables, and has a Fischer ratio which is a molar ratio of a branched chain amino acid to an aromatic amino acid, of 2.1 or higher.

A vegetable used herein may be any of leaf vegetable, fruit vegetable and root vegetable.

Specific examples of the leaf vegetable include chives, Angelica keiskei, asparagus, Aralia cordata, saltwrot, Brassica rapa (leaf), cauliflower, cabbage, red cabbage, Brassica rapa var. laciniifolia (including mizuna and Ailuropoda melanoleuca), watercress, kale, Brassica rapa var. peruviridis, Japanese basil, crowndaisy, leaf ginger, Japanese parsley, celery, Osmunda japonica, Japanese radish sprouts, leaf Japanese radish, Brassica juncea var. intfor examplelifolia, bamboo shoot, common onion, red onion, qing-geng-cai, Japanese vegetable flower (Brassica rapa var. amplexicaulis and its flower), oriental chive, leaf carrot, garlic, stem garlic, green onion (deep root green onion, leaf green onion, small green onion), celery cabbage, basil, parsley, Petasites japonicus Petasites, Petasites japonicus, broccoli, spinach, Japanese honewort (cut type), Zingiber mioga, Brussel sprouts, alfalfa bean sprouts, Jew's marrow, tansy, rakkyo, lettuce, butter lettuce, red-tip leaf lettuce, welsh onion, and bracken.

Specific examples of the fruit vegetable include haricot beans (string beans), green soybeans, runner beans, okra, pumpkin (Japanese pumpkin, Western pumpkin), cucumber, green pepper, field beans (immature), pepper, tunka, sweet corn, tomato, miniature tomato, eggplant, bitter melon (Memordica charantia), bell pepper (green bell pepper, red bell pepper, yellow bell pepper) and Egyptian beans.

Specific examples of the root vegetable include Brassica rapa (root), burdock, ginger, Japanese radish, cut and dried Japanese radish, carrot, miniature carrot, lotus root and Japanese horseradish.

Specific examples of other vegetable include green peas and soybean sprouts.

The powdered health food according to the embodiment may further contain at least one selected from the group consisting of powders of grain, potato, beans, nuts and seeds, fruit, mushroom, and alga.

By further containing at least one selected from the aforementioned group, the powdered health food enables to effectively ingest a nutritional component which is not or little contained in the vegetable (for example, a protein, an amino acid, a lipid, a fatty acid, a carbohydrate, a saccharide, a mineral, a vitamin, a dietary fiber, or the like).

The grain includes, for example, foxtail millet, oat (oat meal), barley, millet, wheat, rice, buckwheat, maize and cockspur.

By further containing a powder of the grain, it is possible to increase a content of a carbohydrate (a saccharide). Thus, the amount of energy of the powdered health food can be increased.

The potato include, for example, Jerusalem artichoke, alimentary yam paste, sweet potato (including violet sweet potato), aroid, dasheen, Irish potato and wild yam (cultivated yam, for example, nagaimo, yamatoimo, jinenjo).

By further containing a powder of the potato, it is possible to increase a content of a mineral (particularly, potassium having a salt regulating action) and a content of the dietary fiber which regulates a function of intestines.

The grain and the potato may be respective processed products thereof. The processed products of the grain and the potato include, for example, bread, noodle (Japanese wheat noodle, Japanese vermicelli, Chinese noodle, macaroni, spaghetti, buckwheat noodles), wheat gluten cake, wheat germ, skin of steam-baked meat pie, skin of Chinese-style steamed meat or shrimp dumpling, pizza crust, rice stick, starch (cassava starch, rice starch, wheat starch, sago starch, sweet potato starch, potato starch), starch saccharide (powder candy, starch syrup, glucose).

According to a disease affected by a subject, there is a case where a sufficient amount of energy is required to be taken but an amount of protein in the powdered health food is required to be limited. Since the grain and the potato include processed products thereof whose nutritional component is mainly a carbohydrate or a saccharide, the sufficient amount of energy can be taken but the amount of the protein in the powdered health food is suitably limited.

The beans include, for example, adzuki beans, haricot beans, peas (green peas, greenish brown peas, sparrow peas, crow peas), black-eyed beans, field beans, soybeans (including soybean flour, soybean protein, processed soybeans (including bean curd, fermented soybeans, bean curd refuse)), black soybeans, black beans, chick-peas), adzuki beans cooked with a saccharide, big broad beans, wild soybeans and sword beans.

By further containing a powder of the beans, it is possible to increase a content of a plant protein and increase a content of an amino acid.

The nuts and seeds include, for example, almonds, ginkgoes, walnuts, coconuts (coconut powder), sesame seeds and peanuts.

The fruit includes, for example, avocado, strawberry, watermelon and banana.

By further containing a powder of the nuts and seeds or the fruit, it is possible to increase a content of a vitamin (particularly, vitamin E, B1, B2, niacin, and B6).

The mushroom includes, for example, enokidake mushroom, Jew's ear, white Jew's ear, shiitake mushroom, shimeji mushroom (hatake shimeji, buna shimeji, hon shimeji), nameko mushroom, thin hiratake mushroom, Pleurotus eryngii, hiratake mushroom, Grifola frondosa, mushroom, matsutake mushroom, truffle, Ganoderma Iucidum, Ganoderma applanatum, and Cordyceps Sinensis.

By further containing a powder of the mushroom, it is possible to increase a content of vitamin D which facilitates absorption of calcium.

The alga includes, for example, green laver, Eisenia bicyclis, purple laver, Campylaephora hypnaeoides, Gracilaria spp, Caulerpa lentillifera, kelp, tangle flakes, Gelidiumelfor exampleans, Meristotheca papulosa, Hizikia fusiformis, Gloiopeltis furcata and brown seaweed.

By further containing a powder of the alga, it is possible to increase a content of a mineral and a water-soluble dietary fiber.

The powdered health food according to the embodiment may contain fat-free powdered milk, special formula powdered milk and casein. By further containing such food, it is possible to increase the content of an amino acid and a taste preference.

Among the above foods (hereinafter referred to as raw material foods), the powdered health food may include, in particular, as the vegetable, at least one of green peas, pumpkin, cauliflower, cabbage, Japanese basil, field beans (immature), onion (including red onion), sweet corn, carrot (including miniature carrot), bell pepper, broccoli, spinach, Brussel sprouts, Jew's marrow and lettuce (including butter lettuce).

If the powdered health food includes another raw material food, the raw material food may be at least one of rice, sweet potato, yam, potato starch, powder candy, sesame seeds, field beans, soybeans, soybean flour, shiitake mushroom, nameko mushroom, kelp and brown seaweed.

A branched chain amino acid (hereinafter referred to as BCAA) herein used is specifically leucine (Leu), isoleucine (Ile) and valine (Val). An aromatic amino acid (hereinafter referred to as AAA) herein used is specifically phenylalanine (Phe) and tyrosine (Tyr).

The Fischer ratio (BCAA/AAA) which is the molar ratio of BCAA to AAA in the powdered health food is 2.1 or higher, preferably 2.5 or higher, and more preferably 3.0 or higher. In the present invention, an upper limit of the Fischer ratio is not particularly limited, but the upper limit of the Fischer ratio is about 3.5 in the powdered health food including a natural raw material food according to the embodiment.

The Fischer ratio in the embodiment is calculated with Formula 1 as follows to obtain a value of a content of isoleucine, leucine, phenylalanine, tyrosine and valine using software (Excel Eiyokun Ver. 4, Shikoku University) created through support of the Ministry of Education, Culture, Sports, Science and Technology.

$$Fischer ratio = \frac{\frac{Σ Ile}{131} + \frac{Σ Leu}{131} + \frac{Σ Val}{117}}{\frac{Σ Phe}{165} + \frac{Σ Tyr}{181}} \qquad ( 1 )$$

In the formula, ΣIle represents a summation of a mass (mg) of isoleucine in the raw material food contained in the powdered health food. Likewise, ΣLeu, ΣVal, ΣPhe and ΣTyr represent summations of the mass (mg) of leucine, valine, phenylalanine and tyrosine, respectively, in the raw material food contained in the powdered health food.

Tables 1 to 3 show examples of food numbers (food numbers described in STANDARD TABLES OF FOOD COMPOSITION IN JAPAN Fifth Revised and Enlarged Edition, the same is applied below), food names, and contents (calculated per 100 g of edible portion using the above software (Excel Eiyokun Ver. 4.0)) of isoleucine, leucine, phenylalanine, tyrosine and valine, of foods which can be used in the present invention.

TABLE 1

| | | Per 100 g of edible part | | | | |
|---|---|---|---|---|---|---|
| | | | | Phenyl- | | |
| Food | | Isoleucine | Leucine | alanine | Tyrosine | Valine |
| number | Food name | (mg) | (mg) | (mg) | (mg) | (mg) |

Vegetables

| | | | | | | |
|---|---|---|---|---|---|---|
| 06007 | Asparagus | 79 | 124 | 83 | 54 | 116 |
| 06010 | String bean (young stem, raw) | 54 | 86 | 54 | 37 | 80 |
| 06015 | Green soybean (raw) | 573 | 942 | 594 | 430 | 594 |
| 06020 | Runner bean (raw) | 79 | 104 | 69 | 41 | 119 |
| 06023 | Green peas (young sheath, raw) | 298 | 496 | 331 | 209 | 331 |
| 06032 | Abelmoschus esculentus (fruit, raw) | 50 | 84 | 63 | 36 | 67 |
| 06036 | Brassica rapa (root, with skin, raw) | 14 | 22 | 13 | 7 | 22 |
| 06046 | Japanese pumpkin (fruit, raw) | 51 | 76 | 46 | 40 | 66 |
| 06048 | Western pumpkin (fruit, raw) | 63 | 100 | 54 | 39 | 72 |
| 06054 | Cauliflower (anthotaxy, raw) | 110 | 163 | 100 | 72 | 158 |
| 06061 | Cabbage (rolled leaves, raw) | 29 | 45 | 27 | 16 | 43 |
| 06065 | Cucumber (fruit, raw) | 27 | 43 | 25 | 17 | 32 |
| 06084 | Burdock (root, raw) | 34 | 43 | 34 | 19 | 40 |
| 06086 | Brassica rapa var. peruviridis (leaf, raw) | 43 | 72 | 52 | 28 | 60 |
| 06099 | Crown daisy (leaf, raw) | 80 | 143 | 92 | 55 | 103 |
| 06119 | Celery (stem, raw) | 20 | 27 | 19 | 12 | 28 |
| 06124 | Field bean (immature bean, raw) | 418 | 749 | 418 | 313 | 488 |
| 06130 | Japanese radish (leaf, raw) | 70 | 123 | 84 | 45 | 95 |
| 06132 | Japanese radish (root, with skin, raw) | 6 | 9 | 5 | 2 | 11 |
| 06136 | Cut and dried Japanese radish | 74 | 109 | 67 | 30 | 127 |
| 06149 | Bamboo shoot (young stem, raw) | 126 | 190 | 109 | 691 | 161 |
| 06153 | Common onion (bulb root, raw) | 17 | 33 | 25 | 15 | 20 |
| 06175 | Sweet corn (immature seeds, raw) | 126 | 374 | 161 | 115 | 172 |
| 06182 | Tomato (fruit, raw) | 15 | 23 | 19 | 11 | 16 |
| 06183 | Miniature tomato (fruit, raw) | 24 | 36 | 29 | 17 | 26 |
| 06191 | Eggplant (fruit, raw) | 36 | 56 | 36 | 22 | 47 |
| 06207 | Oriental chive (leaf, raw) | 62 | 106 | 68 | 43 | 73 |
| 06212 | Carrot (root, with skin, raw) | 17 | 23 | 17 | 10 | 23 |
| 06223 | Garlic (bulb root, raw) | 105 | 182 | 134 | 124 | 182 |
| 06226 | Deep root green onion (leaf, soft white, raw) | 13 | 24 | 14 | 10 | 19 |
| 06227 | Leaf green onion (leaf, raw) | 40 | 72 | 43 | 31 | 57 |
| 06233 | Celery cabbage (bulb roots, raw) | 15 | 21 | 12 | 9 | 21 |
| 06245 | Green bell pepper (fruit, raw) | 27 | 43 | 27 | 18 | 36 |
| 06263 | Broccoli (anthotaxy, raw), | 144 | 240 | 151 | 103 | 206 |
| 06267 | Spinach (leaf, raw) | 63 | 112 | 84 | 56 | 80 |
| 06287 | Soybean young sprout (raw) | 174 | 265 | 187 | 116 | 194 |
| 06312 | Lettuce (bulb roots, raw) | 17 | 24 | 14 | 9 | 20 |
| 06313 | Butter lettuce (leaf, raw) | 57 | 95 | 57 | 32 | 68 |
| 06317 | Lotus root (root stem, raw) | 33 | 48 | 33 | 33 | 45 |

TABLE 2

| | | Per 100 g of edible part (but * per 210 g) | | | | |
|---|---|---|---|---|---|---|
| | | | | Phenyl- | | |
| Food | | Isoleucine | Leucine | alanine | Tyrosine | Valine |
| number | Food name | (mg) | (mg) | (mg) | (mg) | (mg) |

Grains

| | | | | | | |
|---|---|---|---|---|---|---|
| 01083 | Rice (paddy rice grain particle, white rice) | 256 | 512 | 338 | 256 | 389 |
| 01088 | Rice (paddy rice, white rice) | 221 | 441 | 290 | 221 | 334 |
| 01089 | Rice (paddy rice, germ white rice) | 237 | 475 | 313 | 237 | 361 |

Potatoes

| | | | | | | |
|---|---|---|---|---|---|---|
| 02006 | Sweet potato (stem tuber, raw) | 49 | 74 | 67 | 24 | 71 |
| 02010 | Aroid (bulb, raw) | 50 | 120 | 76 | 64 | 79 |
| 02017 | Potato (stem tuber, raw) | 51 | 76 | 64 | 46 | 84 |
| 02023 | Dioscorea batatas (root mass, raw) | 52 | 80 | 66 | 34 | 77 |
| 02025 | Dioscorea japonica (root mass, raw) | 108 | 165 | 136 | 71 | 158 |
| 02026 | Japanese yam (root mass, raw) | 67 | 103 | 85 | 44 | 98 |
| 02034 | Potato starch | 0 | 0 | 0 | 0 | 0 |

Sugars and sweeteners (processed products of Grains and potatoes)

| | | | | | | |
|---|---|---|---|---|---|---|
| 03015 | Powder candy | 0 | 0 | 0 | 0 | 0 |

TABLE 3

| | | Per 100 g of edible part | | | | |
|---|---|---|---|---|---|---|
| | | | | Phenyl- | | |
| Food | | Isoleucine | Leucine | alanine | Tyrosine | Valine |
| number | Food name | (mg) | (mg) | (mg) | (mg) | (mg) |

Beans

| | | | | | | |
|---|---|---|---|---|---|---|
| 04001 | Adzuki beans (whole grains, dry) | 876 | 1559 | 1136 | 519 | 1039 |
| 04007 | Haricot beans (whole grains, dry) | 891 | 1560 | 1082 | 573 | 1050 |
| 04012 | Pease (whole grains, dry) | 902 | 1527 | 1006 | 659 | 1006 |
| 04017 | Black-eyed beans (whole grains, dry) | 1032 | 1797 | 1338 | 726 | 1223 |
| 04019 | Field beans (whole grains, dry) | 1081 | 1830 | 1040 | 748 | 1206 |
| 04023 | Soybeans ((whole grains, domestic, dry) | 1792 | 2905 | 2040 | 1298 | 1854 |
| 04025 | Soybeans (whole grains, made in US, dry) | 1676 | 2716 | 1907 | 1213 | 1733 |
| 04026 | Soybeans (whole grains, made in China, dry) | 1665 | 2859 | 1895 | 1206 | 1723 |
| 04027 | Soybeans (whole grains, made in Brazil, dry) | 1706 | 2765 | 1941 | 1235 | 1765 |
| 04029 | Soy flour (whole grain soybeans) | 1802 | 2859 | 1989 | 1243 | 1865 |
| 04055 | Soybean proteins (participate soybean proteins) | 2351 | 3811 | 2675 | 1702 | 2432 |

Nuts and seeds

| | | | | | | |
|---|---|---|---|---|---|---|
| 05014 | Walnuts (roasted) | 633 | 1101 | 688 | 495 | 743 |
| 05017 | Sesame seeds (dried) | 821 | 1494 | 1008 | 784 | 1083 |
| 05018 | Sesame seeds (roasted) | 842 | 1532 | 1034 | 804 | 1110 |
| 05034 | Peanuts (dried) | 1023 | 1860 | 1488 | 1069 | 1209 |

Mushrooms

| | | | | | | |
|---|---|---|---|---|---|---|
| 08001 | Enokidake mushroom (raw) | 86 | 138 | 86 | 69 | 108 |
| 08011 | Raw shitake mushroom (raw) | 96 | 153 | 96 | 52 | 115 |
| 08013 | Dried shitake mushroom | 617 | 988 | 617 | 339 | 741 |
| 08020 | Nameko mushroom | 68 | 106 | 57 | 29 | 78 |

Algae

| | | | | | | |
|---|---|---|---|---|---|---|
| 09013 | Laminaria diabolica Miyabe (naturally dried) | 387 | 686 | 422 | 211 | 528 |
| 09014 | Kagome konbu (naturally dried) | 278 | 492 | 303 | 151 | 379 |
| 09015 | L. longissima Miyabe (naturally dried) | 292 | 517 | 318 | 159 | 398 |
| 09016 | L. rellgiosa Miyabe (naturally dried) | 242 | 430 | 264 | 132 | 331 |
| 09017 | L. japonica Areschoug (naturally dried) | 288 | 511 | 314 | 157 | 393 |
| 09018 | L. angustata Kjellman (naturally dried) | 271 | 480 | 295 | 147 | 369 |
| 09019 | L. ochotensis Miyabe (naturally dried) | 281 | 499 | 307 | 153 | 384 |
| 09039 | Brown seaweed (original algae, raw) | 94 | 161 | 100 | 45 | 118 |
| 09040 | Dried brown seaweed (naturally dried) | 674 | 1153 | 718 | 326 | 848 |
| 09045 | Aqueous desizing salting brown seaweed | 84 | 144 | 89 | 40 | 106 |
| | (salt removal) | | | | | |
| 09046 | Stem brown seaweed | 54 | 93 | 58 | 26 | 68 |
| | (aqueous desizing salting, salt removal) | | | | | |
| 09047 | Sporophyl brown seaweed (raw) | 44 | 76 | 47 | 21 | 56 |

The Fischer ratio is specifically calculated herein using Formula 1 and Tables 1 to 3. For example, if the powdered health food contains 100 g of carrot (with root and coat, raw, food number: 06212), from Table 1, 17 mg of isoleucine, 23 mg of leucine, 17 mg of phenylalanine, 10 mg of tyrosine and 23 g of valine, are contained therein. Thus, the Fischer ratio is {(17/131)+(23/131)+(23/117)}/{(17/165)+(10/181)}=3.17.

For example, if the powdered health food contains 20 g of carrot (with root and coat, raw, food number: 06212), 40 g of the broccoli (anthotaxy, raw, food number: 06263) and 30 g of western pumpkin (fruit, food number: 06048), the Fischer ratio is {(3.4+57.6+18.9/131)+(4.6+96+30/131)+(4.6+82.4+21.6/117)}/{(3.4+60.4+16.2/165)+(2+41.2+11.7/181)}=3.22.

The Fischer ratio may be calculated using a method other than the above. For example, the Fischer ratio may be calculated by actually measuring the content of an amino acid (BCAA and AAA) contained in the raw material food, the powder thereof, or the powdered health food using a known method (for example, post-column method).

Next is described an example of a method of manufacturing the powdered health food according to the embodiment. The method mainly includes a drying step, a pulverizing step, and a mixing step. Various conditions in each step are appropriately determined by a known technique according to a type of raw material food. Thus, description of the specific condition is omitted.

Each step of the method of manufacturing the powdered health food is described below.

### <Drying Step>

The drying step is a step of drying a raw material food to yield a dried product thereof.

First, a raw material food is selected, inspected, weighed pretreated where needed (for example, removal of foreign substance or unnecessary portion), washed, and is then cut into an appropriate size and thickness. A dimension to be cut may be appropriately selected according to a shape of the raw material food, a type and a volume of a dryer to be used. Washing may be performed again after cutting.

The raw material food is treated such as blanching and boiling, if necessary, and is then dried by heating. The drying by heating shortens a drying time of the raw material food. The drying by heating may have a sterilization effect on the raw material food.

It is not necessary to perform the drying at one time. The drying may be performed in multiple steps, changing a heating temperature or a treating time. For example, a primary drying is performed at 70 to 80° C. for 2 hours, a secondary drying is performed at 50 to 60° for one hour, and a tertiary drying is performed at 30° for 2 hours.

The drying in the step is not limited to be performed by heating, and solar drying or lyophilization may be performed.

### <Pulverizing Step>

The pulverizing step is a step of pulverizing a dried product of the raw material food obtained by the drying step to yield a powder thereof.

An example of a pulverizer used in the step is described next with reference to related drawings.

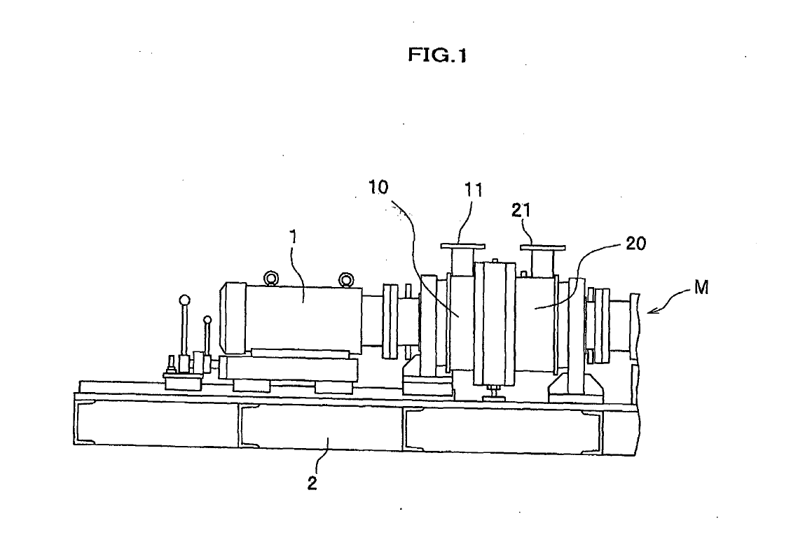

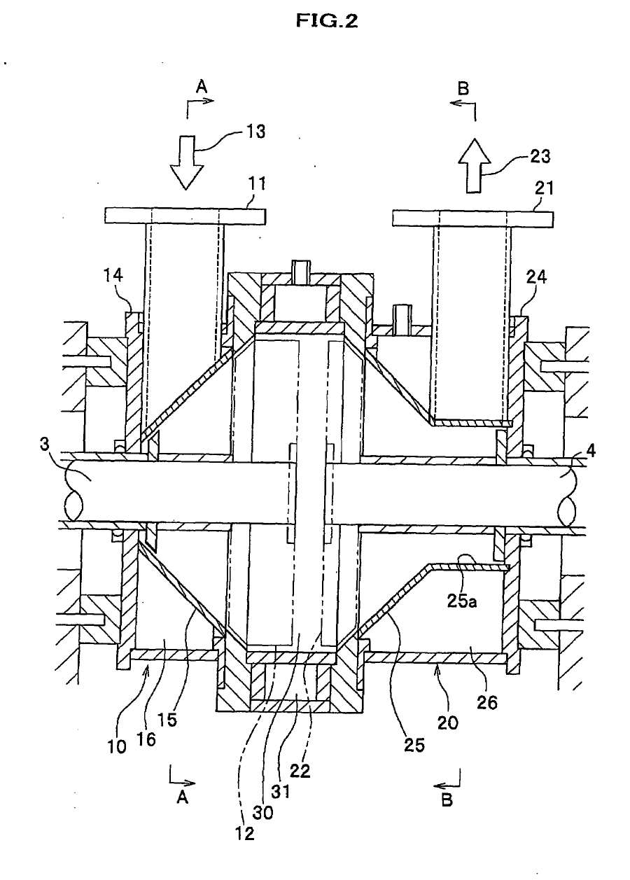

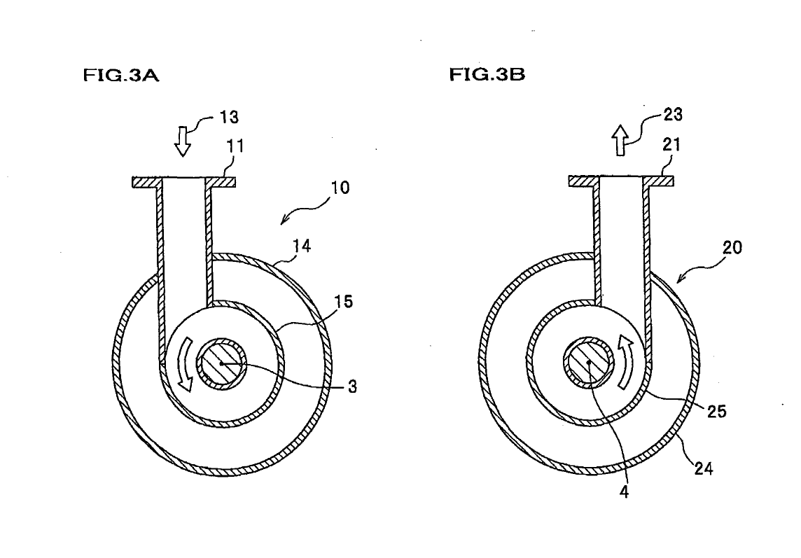

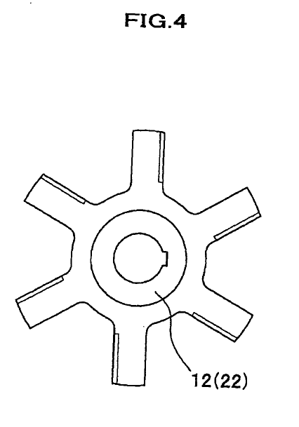

FIG. 1 is an appearance side view of the pulverizer. FIG. 2 is an enlarged sectional view around a pulverizing chamber of the pulverizer. FIG. 3A is a sectional view when cut along the line A-A in FIG. 2, and FIG. 3B is a sectional view when cut along the line B-B in FIG. 2. FIG. 4 is a front view of a rotary wing on a charging side of the pulverizer.

A pulverizer M is attached to rotary axes 3,4 as shown in FIG. 2. In the pulverizer M, an object to be pulverized is introduced from an inlet 11 to a pulverizing chamber 30 formed between a rotary wing 12 on a charging side and a rotary wing 22 on a discharging side (see FIG. 4). The rotary wing 12 and the rotary wing 22 are provided opposing to each other and rotate inside a casing 10 on the charging side and a casing 20 on the discharging side, respectively. A pulverized article obtained by mutual friction of the object is collected from an outlet 21.

As shown in FIG. 3, in the pulverizer M, a charging direction 13 (a centerline of the inlet 11) of the object to be pulverized in the inlet 11 is arranged to be slightly shifted from a rotary center of the rotary wing 12 (rotary axis 3) on the charging side to a forward direction of a rotary direction thereof. A discharging direction 23 (a centerline 21 of the outlet) of the pulverized article in the outlet 21 is arranged to be slightly shifted from a rotary center of the rotary wing (22) (rotary axis 4) on the discharging side to a forward direction of the rotary direction thereof.

In such a configuration, a suction force by the rotation of the rotary wing 12 on the charging side effectively acts upon the object to be pulverized, the suction of the object to be pulverized becomes smooth, and a suction speed becomes high. Thus, the object to be pulverized charged in the inlet 11 is rapidly sucked into the pulverizing chamber 30. A discharging force by the rotation of the rotary wing 22 on the discharging side effectively acts upon the pulverized article. Collection of the pulverized article becomes smooth, and a discharging speed becomes high. Thus, the pulverized article powdered by being pulverized is rapidly collected from the outlet 21. This shortens a retention time of the pulverized article in the casing, and it is possible to reduce thermal denaturation of the object to be pulverized due to the pulverization.

Also as shown in FIG. 2, in the pulverizer M, a cooling jacket 16 is disposed between an outer case 14 and an inner case 15 of the casing 10 on the charging side, a cooling jacket 26 is disposed between an outer case 24 and an inner case 25 of the casing 20 on the discharging side, and a cooling jacket 31 is disposed to surround outside of the pulverizing chamber 30. The jackets 16,26,31 can reduce thermal denaturation of the object to be pulverized due to the pulverization by introducing cooling medium such as a cooling gas or a cooling liquid to cool the casings 10,20 and the pulverizing chamber

Further, as shown in FIG. 2, a cylindrical guide 25a is provided in the pulverizer M. Thus, the powdered pulverized article is sorted to make a discharge thereof easy, as well as to make a control of suction easy. Also, the pulverized article of a desired particle size, for example, of a 50% particle size from several μm to several ten μm can be obtained. Note that a temperature of the pulverizer during processing is 40° C. or below.

Next is described an outline of operations of the pulverizer M including pulverization of a dried product by the pulverizer M.

When a motor 1 (see FIG. 1) is started, the rotary wing 12 on the charging side is rotated anticlockwise as viewed from the motor 1, via the rotary axis 3 as shown in FIG. 3A. When the motor on an opposite side (not shown) is started, the rotary wing 22 on the discharging side is rotated anticlockwise as viewed from the motor (not shown), via the rotary axis 4 as shown in FIG. 3B. At this time, the rotary wing 12 on the charging side and the rotary wing 22 on the discharging side rotate in opposite directions from each other, and swirling airflow is generated in the pulverizing chamber 30 between the rotary wing 12 on the charging side and the rotary wing 22 on the discharging side.

In this state, the dried product obtained in the drying step is charged from the inlet 11, which falls in a direction indicated by an arrow 13, enters the inner case 15 of the casing 10 on the charging side, passes through the rotary wing 12 on the charging side, and is sucked into the pulverizing chamber 30. The dried product introduced into the pulverizing chamber 30 is pulverized and powdered by mutual friction with other dried product. A resultant powder passes through the inner case 25 of the casing 20 on the discharging side, further passes through the cylindrical guide 25a, and is collected from the outlet 21 via a suction duct (not shown).

During the pulverization, a cooling medium may be circulated in the jackets 16,26,31. The cooling medium absorbs heat generated by the pulverization, thus reducing thermal denaturation of the obtained powder.

The pulverizing step is performed for each raw material food individually to obtain powders thereof.

The pulverizer used in this step is not limited to the pulverizer having the above configuration, and any generally available pulverizer may be used. However, a pulverizer capable of obtaining a pulverized product having a 50% particle size from 10 to 30 μm is preferable. Note that digestive absorbability of the pulverized product (powdered health food) is enhanced, as a particle size thereof becomes smaller.

### <Mixing Step>

The mixing step is a step of mixing powders of the raw material foods obtained in the pulverizing step to obtain a mixture thereof (a powdered health food). A specific amount and ratio to be mixed are appropriately determined.

In the mixing step, herb, yeast, lactic acid bacteria, carbohydrate, saccharide, lipid, fatty acid, mineral, vitamin, dietary fiber, pigment, perfume, enzyme, amino acid and the like may be added when appropriate. For example, a starch or the like may be added to and mixed with a powdered raw material food that contains a relatively large amount of sugar, in order to avoid a mass from being generated in the mixing step.

The mixing step may be performed simultaneously with the pulverizing step. That is, predetermined amounts of multiple raw material foods (dried products) may be put in a pulverizer (for example, the pulverizer M) in operation to pulverize and mix them.

After the above steps, if necessary, one or more steps such as homogenization of powder particles by a sieve, removal of iron by a magnet, and metal inspection by a metal detector may be performed.

The powdered health food according to the embodiment can be manufactured at low cost by just mixing powders of natural raw material foods such as a vegetable. The powdered health food tastes good, because the natural raw material foods such as a vegetable keep their taste even in the manufactured powdered health food without being degraded into an amino acid or a peptide. Therefore, the powdered health food can be ingested on a daily basis and can be ingested not only by those having a lowered hepatic function but also by those with an intention of preventing their hepatic function from lowering.

The powdered health food according to the embodiment has the Fischer ratio of 2.1 or higher and excellent digestive absorbability due to its powdered form. Hence, the powdered health food makes it possible to effectively distribute a branched chain amino acid or other nutritional component throughout an entire body of a subject who takes the powdered health food, improve the Fischer ratio in blood of the subject, and enhance autoimmunity thereof. This may help improve protein synthesis or ammonia metabolism in a liver thereof, and improve or maintain a hepatic function thereof.

The embodiment of the present invention has been explained as aforementioned. However, the embodiment of the present invention is not limited to the explanation. A specific configuration of the embodiment may be changed where appropriate without departing from a gist of the present invention.

For example, in the above embodiment, the powdered health food according to the present invention is described as a food for a human, but may also be provided as a food for a pet such as a dog and a cat. A conventional food for a pet does not take the Fischer ratio into account. The powdered health food according to the present invention is useful in improving the Fischer ratio in blood of a pet having a lowered hepatic function, and in improving and maintaining the hepatic function thereof.

If the powdered health food is used as a food for a pet, some raw material foods such as onion and welsh onion may not be used, because onion and welsh onion produce anemia to a dog or a cat. Thus, if the powdered health food according to the present invention is given to a pet, the powdered health food should not contain a raw material food which is undesirable to a pet.

Table 4 and Table 5 show food numbers, food names, and usability or unusability of food indicating that the food can be used or are not preferable to be used, if the powdered health food according to the present invention is given to a pet. In columns of the usability or unusability of food, sings of A, B, C and D mean foods that can be used particularly preferably, foods that can be used preferably, food that can be used, and food that are not preferable to be used, respectively.

TABLE 4

| | | |
|---|---|---|
| Food | | usability or |
| number | Food name | unusability |

Vegetables

| | | |
|---|---|---|
| 06003 | Chive | D |
| 06005 | Angelica keiskei | A |
| 06007 | Asparagus | A |
| 06010 | String bean | A |
| 06012 | Aralia cordata | D |
| 06015 | Green soybeans, | A |
| 06020 | Runner beans | B |
| 06023 | Green pea | A |
| 06030 | Saltwrot | A |
| 06032 | Abelmoschus esculentus | B |
| 06034 | Brassica rapa (leaf) | A |
| 06036 | Brassica rapa (root) | A |
| 06046 | Japanese pumpkin | A |
| 06048 | Western pumpkin | A |
| 06054 | Cauliflower | A |
| 06061 | Cabbage | A |
| 06064 | Red cabbage | A |
| 06065 | Cucumber | A |
| 06072 | Kyouna | A |
| 06077 | Watercress | A |
| 06080 | Kale | A |
| 06084 | Burdock | B |
| 06086 | Brassica rapa var. peruviridis | A |
| 06093 | Green pepper | C |
| 06095 | Japanese basil | A |
| 06099 | Crown daisy | A |
| 06102 | Leaf ginger | C |
| 06103 | Ginger | C |
| 06117 | Japanese parsley | A |
| 06119 | Celery | A |
| 06122 | Osmunda japonica | C |
| 06124 | Field bean | B |
| 06128 | Japanese radish sprout | A |
| 06130 | Leaf Japanese radish | A |
| 06132 | Japanese radish | A |
| 06136 | Cut and dried Japanese radish | A |
| 06147 | Brassica juncea var. integlifolia | A |
| 06149 | Bamboo shoot | C |
| 06153 | Common onion | D |
| 06156 | Red onion | D |
| 06160 | Qing-geng-cai | A |
| 06169 | Chili pepper | D |
| 06173 | Tunka | A |
| 06175 | Sweet corn | A |
| 06182 | Tomato | A |
| 06183 | Miniature tomato | A |
| 06191 | Eggplant | B |
| 06201 | Japanese vegetable flower | A |
| 06205 | Bitter melon | B |
| 06207 | Oriental chive | D |
| 06211 | Leaf carrot | A |
| 06212 | Carrot | A |
| 06222 | Miniature carrot | A |
| 06223 | Garlic | D |
| 06224 | Stem garlic | D |
| 06226 | Deep root green onion | D |
| 06227 | Leaf green onion | D |
| 06228 | Small onion | D |
| 06233 | White cabbage | A |
| 06238 | Basil | A |
| 06239 | Parsley | A |
| 06245 | Green bell pepper | A |
| 06247 | Red bell pepper | A |
| 06249 | Yellow bell pepper | A |
| 06256 | Petasites japonicus Petasites | A |
| 06258 | Petasites japonicus | B |
| 06260 | Egyptian bean | B |
| 06263 | Broccoli | A |
| 06267 | Spinach | A |
| 06274 | Cut Japanese honewort | A |
| 06280 | Zingiber mioga | D |
| 06283 | Brussels sprout, | A |
| 06286 | Alfalfa bean sprout | A |
| 06287 | Soybean sprout | A |
| 06293 | Jew's marrow, | A |
| 06301 | Tansy | C |
| 06305 | Rakkyo | D |
| 06312 | Lettuce | A |
| 06313 | Butter lettuce | A |
| 06315 | Red-tip leaf lettuce | A |
| 06317 | Lotus root | B |
| 06322 | Welsh onion | D |
| 06326 | Bracken | C |

TABLE 5

| | | |
|---|---|---|
| Food | | usability or |
| number | Food name | unusability |

Grains

| | | |
|---|---|---|
| 01004 | Oat meal | B |
| 01026 | Bread | A |
| 01039 | Japanese wheat noodle (boiled) | A |
| 01044 | Japanese vermicelli (boiled) | A |
| 01064 | Macaroni and spaghetti (boiled) | A |
| 01070 | Wheat germ | B |
| 01074 | Skin of steam-baked meat pie | B |
| 01075 | Skin of Chinese-style steamed | B |
| | meat or shrimp dumpling | |
| 01076 | Pizza crust | C |
| 01083 | Rice (paddy rice corn, white rice) | B |
| 01088 | Rice (paddy rice, white rice) | A |
| 01089 | Rice (paddy rice, germ white rice) | A |
| 01093 | Rice ((paddy rice mush, white rice) | A |
| 01115 | Rice sticks | A |

Potatoes

| | | |
|---|---|---|
| 02001 | Jerusalem artichoke | A |
| 02006 | Sweet potato | A |
| 02010 | Aroid | B |
| 02017 | Irish potato | A |
| 02023 | Yams-nagaimo | C |
| 02025 | Yams-Yamatoimo | C |
| 02026 | Yams-jinenjo | C |
| 02034 | Irish potato starch | A |

Processed products of Grains and potatoes

| | | |
|---|---|---|
| 03015 | Powdered candy | A |

Mushrooms

| | | |
|---|---|---|
| 08001 | Enokidake-mushroom | C |
| 08006 | Jew's ear | C |
| 08008 | white Jew's ear | C |
| 08011 | Raw shitake-mushroom | C |
| 08013 | Dried shitake-mushroom | A |
| 08015 | Hatake-shimeji mushroom | C |
| 08016 | Buna shimeji mushroom | C |
| 08018 | Hon shimeji mushroom | C |
| 08020 | Nameko mushroom | C |
| 08024 | Thin hiratake mushroom | C |
| 08025 | Pleurotus eryngii | C |
| 08026 | Hiratake mushroom | C |
| 08028 | Grifola frondosa | C |
| 08031 | Mushroom | C |
| 08034 | Matsutake mushroom | C |

Beans

| | | |
|---|---|---|
| 04001 | Adzuki bean | B |
| 04007 | Haricot beans | B |
| 04012 | Pease | B |
| 04017 | Black-eyed beans | B |
| 04019 | Field bean | A |
| 04023 | Soybean (domestic, dried) | A |
| 04025 | Soybean (made in US) | A |
| 04026 | Soybean (made in China) | A |
| 04027 | Soybean (made in Brazil) | A |
| 04029 | Soybean flour (whole particle soybean) | A |
| 04032 | Hard soybean curd | A |
| 04033 | Soft soybean curd | A |
| 04038 | Baked soybean curd | A |
| 04042 | Frozen soybean curd | A |
| 04047 | Ground fermented soybeans | A |
| 04055 | Particulate soybean protein | A |
| — | Soybean curd refuse | A |

Nuts and seeds

| | | |
|---|---|---|
| 05001 | Almond | B |
| 05014 | Walnut | B |
| 05016 | Coconut powder | C |
| 05017 | Sesame seeds (dried) | B |
| 05018 | Sesame seeds (roasted) | A |
| 05034 | Peanut | D |

Algae

| | | |
|---|---|---|
| 09004 | Eisenia bicyclis (toast laver) | B |
| 09013 | Kjellmaniella crassifolia | B |
| 09014 | Laminaria longissima | B |
| 09015 | Laminaria religiosa | B |
| 09016 | Laminaria japonica | B |
| 09017 | Laminaria angustata | B |
| 09018 | Laminaria angustata | B |
| 09019 | Aphanothece sacrum | B |
| 09026 | Meristotheca papulosa (tokoroten) | B |
| 09028 | Meristotheca papulosa (agar) | B |
| 09031 | Dried Hizikia fusiformis | B |
| 09039 | Brown seaweed (original algae, raw) | B |
| 09040 | Dried brown seaweed (natural dry) | B |
| 09045 | Aqueous desizing salting brown seaweed | A |
| 09046 | Stem brown seaweed | A |
| 09047 | Sporophyl brown seaweed | B |

If the powdered health food according to the present invention is given to a pet, the powdered health food may be added to at least one food selected from the group consisting of grain, fish and shellfish, meat, eggs, and milk. The food which is used particularly preferably may be as follows.

The grain includes, for example, white rice (cooked paddy rice or total rice gruel), germ white rice (cooked paddy rice), bread, Japanese wheat noodles (boiled), Japanese vermicelli (boiled), and macaroni/spaghetti (boiled).

The fish and shellfish includes, for example, sardine, skipjack, salmon, mackerel, saury (including a processed product thereof), shishamo smelt, sea bream, codfish, yellowtail, tuna (including processed products), and boiled-dried fish.

The meat includes, for example, cattle (red meat), cattle liver, horse (red meat), deer (red meat), pig (red meat), young chicken (breast, breast tender), and chicken liver.

The eggs include, for example, chicken eggs (whole egg or egg yolk).

The milk includes, for example, ordinary cow milk, fat-free milk, fat-free powdered milk, yogurt (whole milk no saccharide), and natural cheese (Camembert).

Fruit, oil and fat, honey, and maple syrup may also be added. The fruit includes, for example, avocado, strawberry and banana. The oil and fat includes, for example, olive oil, sunflower seed oil (high oleic acid purified oil), and grape seed oil.

Herb, yeast, lactic acid bacteria, carbohydrate, saccharide, lipids, fatty acid, mineral, vitamin, dietary fiber, pigment, perfume, enzyme, amino acid, and the like may also be added, for example, if necessary.

### EXAMPLES

Examples of the present inventions are described below.

Table 6 shows food numbers, food names, and contents of the amino acids (BCAA, AAA) per 100 g of edible portions of raw material foods used in the Examples. In Table 6, processed products mean processed products of grain and potato.

TABLE 6

| | | | Per 100 g of edible part | | | | |
|---|---|---|---|---|---|---|---|
| | | | | | Phenyl- | | |
| | Food | | Isoleucine | Leucine | alanine | Tyrosine | Valine |
| | number | Food name | (mg) | (mg) | (mg) | (mg) | (mg) |
| Vegetables | 06048 | Western pumpkin (fruit, raw) | 63 | 100 | 54 | 39 | 72 |
| | 06061 | Cabbage (headed leaves, raw) | 29 | 45 | 27 | 16 | 43 |
| | 06212 | Carrot (roots, with coat, raw) | 17 | 23 | 17 | 10 | 23 |
| | 06263 | Broccoli (anthotaxy, raw) | 144 | 240 | 151 | 103 | 206 |
| Grains | 01015 | Wheat flour (soft flour, first class) | 308 | 603 | 421 | 238 | 350 |
| Processed | 02034 | Potato starch | 0 | 0 | 0 | 0 | 0 |
| products | 03015 | Powder candy | 0 | 0 | 0 | 0 | 0 |
| Beans | 04029 | Soybean flour (whole grain soybean) | 1802 | 2859 | 1989 | 1243 | 1865 |
| Nuts and | 05018 | Sesame seeds (roasted) | 842 | 1532 | 1034 | 804 | 1110 |
| seeds | | | | | | | |
| Mushrooms | 08013 | Dried shiitake mushroom (dried) | 617 | 988 | 617 | 339 | 741 |
| Others | 13010 | Powdered skimmed milk | 1758 | 3304 | 1652 | 1598 | 2131 |
| | 17014 | Purified salt | 0 | 0 | 0 | 0 | 0 |

First, dried products of western pumpkin (fruit, raw, food number: 06048), cabbage (headed leaves, raw, food number: 06061), carrot (roots, with coat, raw, food number: 06212) and broccoli (anthotaxy, raw, food number: 06263) were obtained with procedures and conditions shown below.

### <Western Pumpkin>

A whole pumpkin, especially its coat and stem end was washed and was cut into quarters. The stem end and seeds were removed. A remaining portion of the pumpkin, especially its inner side was thoroughly washed with running water. The pumpkin was sliced into long thin strips having a length not more than 5 cm and a thickness not more than 1 mm. The strips were put on a drying grid and were dried by heating (80° C., 4 hours) using a hot air dryer to obtain the dried product of western pumpkin.

### <Cabbage>

Outer leaves of a cabbage were removed. The cabbage was washed, cut into quarters, and washed again with running water. The cabbage was then sliced into long thin strips having a length not more than 5 cm and a thickness not more than 1 mm. The strips were uniformly put on a drying grid and dried by heating (80° C., 4 hours) using a hot air dryer to obtain the dried product of cabbage.

### <Carrot>

A carrot was trimmed (removal of a foreign matter and unnecessary portion), washed, and sliced into 3 mm×6 mm. The sliced carrot was boiled (90° C., 2 minutes) and drained off. The carrot was then dried by heating (60° C., 9 hours) using a hot air dryer to obtain the dried product of carrot.

### <Broccoli>

A broccoli was washed, and stem thereof was removed. The broccoli was washed again, blanched (93° C., 120 to 180 seconds), cooled, and drained well. The broccoli was dried by heating by changing conditions including a primary drying (70 to 80° C., 2 hours), a secondary drying (50 to 60° C., 1 hour), and a tertiary drying (30° C., 2 hours) using a hot air dryer to obtain the dried product of broccoli.

The dried products of western pumpkin, cabbage, carrot, and broccoli obtained as above, sesame seeds (roasted, food number: 05018), and dried shiitake mushroom (dried, food number: 08013) were individually put in a pulverizer (Econamil (registered trademark) supplied by K.K. Powder Nova), and were pulverized to yield respective powders. Rotational frequencies of the rotary wings on the charging side and on the discharging side were both 4,200 rpm.

Examples 1 to 11 of the powdered health foods manufactured by mixing the obtained powders as above, potato starch (food number: 02034), and powder candy (food number: 03015) are described below.

Tables 7 to 17 each show food names, mixed amounts (in powder amount), contents of amino acids (BCAA, AAA), and the Fischer ratios in the respective Examples.

### Example 1

2.24 g (corresponding to 20 g raw) of the carrot powder, 3.52 g (corresponding to 40 g raw) of the broccoli powder, 6.9 g (corresponding to 30 g raw) of the western pumpkin powder, 1 g of the dried shiitake mushroom powder, 50 g of the potato starch, and 10 g of the powder candy were mixed to obtain a powdered health food of Example 1 shown in Table 7. The Fischer ratio of the powdered health food of Example 1 was 3.22.

TABLE 7

| | | | Dried | Powder | | | Phenyl- | | | |
|---|---|---|---|---|---|---|---|---|---|---|
| Food | | Mass | ratio | amount | Isoleucine | Leucine | alanine | Tyrosine | Valine | Fischer |
| number | Food name | (g) | (%) | (g) | (mg) | (mg) | (mg) | (mg) | (mg) | ratio |
| 06212 | Carrot | 20 | 11.2 | 2.24 | 3.4 | 4.6 | 3.4 | 2.0 | 4.6 | |
| 06263 | Broccoli | 40 | 8.8 | 3.52 | 57.6 | 96.0 | 60.4 | 41.2 | 82.4 | |
| 06048 | Western pumpkin | 30 | 23.0 | 6.90 | 18.9 | 30.0 | 16.2 | 11.7 | 21.6 | |
| 08013 | Dried shiitake mushroom | 1 | — | 1 | 6.17 | 9.88 | 6.17 | 3.39 | 7.41 | |
| 02034 | Potato starch | 50 | — | 50 | 0 | 0 | 0 | 0 | 0 | |
| 03015 | Powder candy | 10 | — | 10 | 0 | 0 | 0 | 0 | 0 | |
| Total | | 91 | — | 73.66 | 86.07 | 140.48 | 86.17 | 58.29 | 116.01 | 3.22 |

### Example 2

5.6 g (corresponding to 50 g raw) of the carrot powder, 50 g of the potato starch, 20 g of the powder candy, and 20 g of soybean flour (whole soybeans, food number: 04029) was mixed to obtain a powdered health food of Example 2 shown in Table 8. The Fischer ratio of the powdered health food of Example was 2.73.

TABLE 8

| | | | Dried | Powder | | | Phenyl- | | | |
|---|---|---|---|---|---|---|---|---|---|---|
| Food | | Mass | ratio | amount | Isoleucine | Leucine | alanine | Tyrosine | Valine | Fischer |
| number | Food name | (g) | (%) | (g) | (mg) | (mg) | (mg) | (mg) | (mg) | ratio |
| 06212 | Carrot | 50 | 11.2 | 5.6 | 8.5 | 11.5 | 8.5 | 5.0 | 11.5 | |
| 02034 | Potato starch | 50 | — | 50 | 0 | 0 | 0 | 0 | 0 | |
| 03015 | Powder candy | 20 | — | 20 | 0 | 0 | 0 | 0 | 0 | |
| 04029 | Soybean powder | 20 | — | 20 | 360.4 | 571.8 | 397.8 | 248.6 | 373.0 | |
| Total | | 140 | — | 95.6 | 368.9 | 583.3 | 406.3 | 253.6 | 384.5 | 2.73 |

### Example 3

5.6 g (corresponding to 50 g raw) of the carrot powder, 20 g of wheat flour (soft flour, first grade, food number: 01015), 80 g of the potato starch, 30 g of the powder candy, 30 g of the soybean flour and 20 g of fat-free powdered milk (food number: 13010) was mixed to obtain a powdered health food of Example shown in Table 9. The Fischer ratio of the powdered health food of Example 3 was 2.82.

TABLE 9

| | | | Dried | Powder | | | Phenyl- | | | |
|---|---|---|---|---|---|---|---|---|---|---|
| Food | | Mass | ratio | amount | Isoleucine | Leucine | alanine | Tyrosine | Valine | Fischer |
| number | Food name | (g) | (%) | (g) | (mg) | (mg) | (mg) | (mg) | (mg) | ratio |
| 06212 | Carrot | 50 | 11.2 | 5.6 | 8.5 | 11.5 | 8.5 | 5.0 | 11.5 | |
| 01015 | Wheat flour | 20 | — | 20 | 61.6 | 120.6 | 84.2 | 47.6 | 70.0 | |
| 02034 | Potato starch | 80 | — | 80 | 0 | 0 | 0 | 0 | 0 | |
| 03015 | Powder candy | 30 | — | 30 | 0 | 0 | 0 | 0 | 0 | |
| 04029 | Soybean flour | 30 | — | 30 | 540.6 | 857.7 | 596.7 | 372.9 | 559.5 | |
| 13010 | Fat-free powdered milk | 20 | — | 20 | 351.6 | 660.8 | 330.4 | 319.6 | 426.2 | |
| Total | | 230 | — | 185.6 | 962.3 | 1650.6 | 1019.8 | 745.1 | 1067.2 | 2.82 |

### Example 4

25.57 g (corresponding to 100 g raw) of the western pumpkin powder, 20 g of the wheat flour, 80 g of the potato starch, 20 g of the powder candy, 30 g of the soybean flour, 20 g of the fat-free powdered milk, and 0.2 g of purified salt (food number: 17014) was mixed to obtain a powdered health food of Example 4 shown in Table 10. The Fischer ratio of the powdered health food of Example 4 was 2.85.

TABLE 10

| | | | Dried | Powder | | | Phenyl- | | | |
|---|---|---|---|---|---|---|---|---|---|---|
| Food | | Mass | ratio | amount | Isoleucine | Leucine | alanine | Tyrosine | Valine | Fischer |
| number | Food name | (g) | (%) | (g) | (mg) | (mg) | (mg) | (mg) | (mg) | ratio |
| 06048 | Western pumpkin | 100 | 25.57 | 25.57 | 63.0 | 100.0 | 54.0 | 39.0 | 72.0 | |
| 01015 | Wheat flour | 20 | — | 20 | 61.6 | 120.6 | 84.2 | 47.6 | 70.0 | |
| 02034 | Potato starch | 80 | — | 80 | 0 | 0 | 0 | 0 | 0 | |
| 03015 | Powder candy | 20 | — | 20 | 0 | 0 | 0 | 0 | 0 | |
| 04029 | Soybean flour | 30 | — | 30 | 540.6 | 857.7 | 596.7 | 372.9 | 559.5 | |
| 13010 | Fat-free powdered milk | 20 | — | 20 | 351.6 | 660.8 | 330.4 | 319.6 | 426.2 | |
| 17014 | Purified salt | 0.2 | — | 0.2 | 0 | 0 | 0 | 0 | 0 | |
| Total | | 270.2 | — | 195.77 | 1016.8 | 1739.1 | 1065.3 | 779.1 | 1127.7 | 2.85 |

### Example 5

1.76 g (corresponding to 20 g raw) of the cabbage powder, 2.24 g (corresponding to 20 g raw) of the carrot powder, 1.76 g (corresponding to 20 g raw) of the broccoli powder, 7.67 g (corresponding to 30 g raw) of the western pumpkin powder, 1 g of the dried shiitake mushroom powder, 50 g of the potato starch, and 10 g of powder candy was mixed to obtain a powdered health food of Example 5 shown in Table 11. The Fischer ratio of the powdered health food of Example 5 was 3.29.

TABLE 11

| | | | Dried | Powder | | | Phenyl- | | | |
|---|---|---|---|---|---|---|---|---|---|---|
| Food | | Mass | ratio | amount | Isoleucine | Leucine | alanine | Tyrosine | Valine | Fischer |
| number | Food name | (g) | (%) | (g) | (mg) | (mg) | (mg) | (mg) | (mg) | ratio |
| 06061 | Cabbage | 20 | 8.8 | 1.76 | 5.8 | 9.0 | 5.4 | 3.2 | 8.6 | |
| 06212 | Carrot | 20 | 11.2 | 2.24 | 3.4 | 4.6 | 3.4 | 2.0 | 4.6 | |
| 06263 | Broccoli | 20 | 8.8 | 1.76 | 28.8 | 48.0 | 30.2 | 20.6 | 41.2 | |
| 06048 | Western pumpkin | 30 | 25.57 | 7.67 | 18.9 | 30.0 | 16.2 | 11.7 | 21.6 | |
| 08013 | Dried shiitake mushroom | 1 | — | 1 | 6.17 | 9.88 | 6.17 | 3.39 | 7.41 | |
| 02034 | Potato starch | 50 | — | 50 | 0 | 0 | 0 | 0 | 0 | |
| 03015 | Powder candy | 10 | — | 10 | 0 | 0 | 0 | 0 | 0 | |
| Total | | 151 | — | 74.43 | 63.07 | 101.48 | 61.37 | 40.89 | 83.41 | 3.29 |

### Example 6

25.57 g (corresponding to 100 g raw) of the western pumpkin powder, 3.36 g (corresponding to 30 g raw) of the carrot powder, 30 g of the potato starch, 10 g of the powder candy, and 20 g of the fat-free powdered milk was mixed to obtain a powdered health food of Example 6 shown in Table 12. The Fischer ratio of the powdered health food of Example 6 was 3.07.

TABLE 12

| | | | Dried | Powder | | | Phenyl- | | | |
|---|---|---|---|---|---|---|---|---|---|---|
| Food | | Mass | ratio | amount | Isoleucine | Leucine | alanine | Tyrosine | Valine | Fischer |
| number | Food name | (g) | (%) | (g) | (mg) | (mg) | (mg) | (mg) | (mg) | ratio |
| 06048 | Western pumpkin | 100 | 25.57 | 25.57 | 63.0 | 100.0 | 54.0 | 39.0 | 72.0 | |
| 06212 | Carrot | 30 | 11.2 | 3.36 | 5.1 | 6.9 | 5.1 | 3.0 | 6.9 | |
| 02034 | Potato starch | 30 | — | 30 | 0 | 0 | 0 | 0 | 0 | |
| 03015 | Powder candy | 10 | — | 10 | 0 | 0 | 0 | 0 | 0 | |
| 13010 | Fat-free powdered milk | 20 | — | 20 | 351.6 | 660.8 | 330.4 | 319.6 | 426.2 | |
| Total | | 190 | — | 88.93 | 419.7 | 767.7 | 389.5 | 361.6 | 505.1 | 3.07 |

### Example 7

3.36 g (corresponding to 30 g raw) of the carrot powder, 2.64 g (corresponding to 30 g raw) of the broccoli powder, 40 g of the potato starch, and 20 g of the powder candy was mixed to obtain a powdered health food of Example 7 shown in Table 13. The Fischer ratio of the powdered health food of Example was 3.16.

TABLE 13

| | | | Dried | Powder | | | Phenyl- | | | |
|---|---|---|---|---|---|---|---|---|---|---|
| Food | | Mass | ratio | amount | Isoleucine | Leucine | alanine | Tyrosine | Valine | Fischer |
| number | Food name | (g) | (%) | (g) | (mg) | (mg) | (mg) | (mg) | (mg) | ratio |
| 06212 | Carrot | 30 | 11.2 | 3.36 | 5.1 | 6.9 | 5.1 | 3.0 | 6.9 | |
| 06263 | Broccoli | 30 | 8.8 | 2.64 | 43.2 | 72.0 | 45.3 | 30.9 | 61.8 | |
| 02034 | Potato starch | 40 | — | 40 | 0 | 0 | 0 | 0 | 0 | |
| 03015 | Powder candy | 20 | — | 20 | 0 | 0 | 0 | 0 | 0 | |
| Total | | 120 | — | 66 | 48.3 | 78.9 | 50.4 | 33.9 | 68.7 | 3.16 |

### Example 8

8.8 g (corresponding to 100 g raw) of the cabbage powder, 50 g of the potato starch, 20 g of the powder candy, and 15 g of the sesame powder was mixed to obtain a powdered health food of Example 8 shown in Table 14. The Fischer ratio of the powdered health food of Example 8 was 2.73.

TABLE 14

| | | | Dried | Powder | | | Phenyl- | | | |
|---|---|---|---|---|---|---|---|---|---|---|
| Food | | Mass | ratio | amount | Isoleucine | Leucine | alanine | Tyrosine | Valine | Fischer |
| number | Food name | (g) | (%) | (g) | (mg) | (mg) | (mg) | (mg) | (mg) | ratio |
| 06061 | Cabbage | 100 | 8.8 | 8.8 | 29.0 | 45.0 | 27.0 | 16.0 | 43.0 | |
| 02034 | Potato starch | 50 | — | 50 | 0 | 0 | 0 | 0 | 0 | |
| 03015 | Powder candy | 20 | — | 20 | 0 | 0 | 0 | 0 | 0 | |
| 05018 | Sesame seeds | 15 | — | 15 | 126.3 | 229.8 | 155.1 | 120.6 | 166.5 | |
| Total | | 185 | — | 93.8 | 155.3 | 274.8 | 182.1 | 136.6 | 209.5 | 2.73 |

### Example 9

4.4 g (corresponding to 50 g raw) of the broccoli powder, 20 g of the soybean flour, and 0.3 g of the purified salt was mixed to obtain a powdered health food of Example 9 shown in Table 15. The Fischer ratio of the powdered health food of Example 9 was 2.79.

TABLE 15

| | | | Dried | Powder | | | Phenyl- | | | |
|---|---|---|---|---|---|---|---|---|---|---|
| Food | | Mass | ratio | amount | Isoleucine | Leucine | alanine | Tyrosine | Valine | Fischer |
| number | Food name | (g) | (%) | (g) | (mg) | (mg) | (mg) | (mg) | (mg) | ratio |
| 06263 | Broccoli | 50 | 8.8 | 4.4 | 72.0 | 120.0 | 75.5 | 51.5 | 103.0 | |
| 04029 | Soybean flour | 20 | — | 20 | 360.4 | 571.8 | 397.8 | 248.6 | 373.0 | |
| 17014 | Purified salt | 0.3 | — | 0.3 | 0 | 0 | 0 | 0 | 0 | |
| Total | | 70.3 | — | 24.7 | 432.4 | 691.8 | 473.3 | 300.1 | 476.0 | 2.79 |

### Example 10

2.24 g (corresponding to 20 g raw) of the carrot powder and 7.04 g (corresponding to 80 g raw) of the broccoli powder was mixed to obtain a powdered health food of Example 10 shown in Table 16. The Fischer ratio of the powdered health food of Example 10 was 3.16.

TABLE 16

| | | | Dried | Powder | | | Phenyl- | | | |
|---|---|---|---|---|---|---|---|---|---|---|
| Food | | Mass | ratio | amount | Isoleucine | Leucine | alanine | Tyrosine | Valine | Fischer |
| number | Food name | (g) | (%) | (g) | (mg) | (mg) | (mg) | (mg) | (mg) | ratio |
| 06212 | Carrot | 20 | 11.2 | 2.24 | 3.4 | 4.6 | 3.4 | 2.0 | 4.6 | |
| 06263 | Broccoli | 80 | 8.8 | 7.04 | 115.2 | 192.0 | 120.8 | 82.4 | 164.8 | |
| Total | | 100 | — | 9.28 | 118.6 | 196.6 | 124.2 | 84.4 | 169.4 | 3.16 |

### Example 11

5.6 g (corresponding to 50 g raw) of the carrot powder and 5 g of the sesame powder was mixed obtain a powdered health food of Example 11 shown in Table 17. The Fischer ratio of the powdered health food of Example 11 was 2.65.

TABLE 17

| | | | Dried | Powder | | | Phenyl- | | | |
|---|---|---|---|---|---|---|---|---|---|---|
| Food | | Mass | ratio | amount | Isoleucine | Leucine | alanine | Tyrosine | Valine | Fischer |
| number | Food name | (g) | (%) | (g) | (mg) | (mg) | (mg) | (mg) | (mg) | ratio |
| 06212 | Carrot | 50 | 11.2 | 5.6 | 8.5 | 11.5 | 8.5 | 5.0 | 11.5 | |
| 05018 | Sesame seeds | 5 | — | 5 | 42.1 | 76.6 | 51.7 | 40.2 | 55.5 | |
| Total | | 55 | — | 10.6 | 50.6 | 88.1 | 60.2 | 45.2 | 67.0 | 2.65 |

### [Administration Study]

An administration test of the powdered health food according to the present invention is described next with reference to the drawings.

### <Test Animals>

Five model dogs with a portal systemic shunt (PSS) were used in the study as test animals. Body weight, dog type, gender and age (at a start of a preliminary study) of the PSS model dogs (test dogs) are shown below.

Test dog 1: 9 kg/beagle/female/1.6 years old

Test dog 2: 9 kg/beagle/female/1.6 years old

Test dog 3: 8 kg/beagle/female/1.6 years old

Test dog 4: 15 kg/mix (crossbreed)/female/11 years old

Test dog 5: 15 kg/mix (crossbreed)/male/4.6 years old

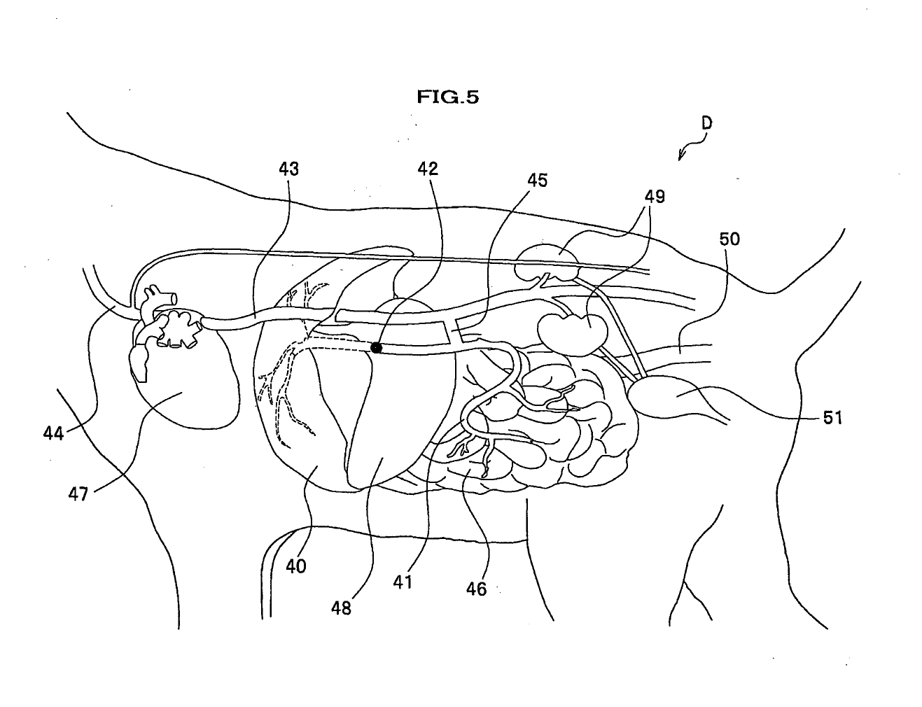

FIG. 5 is a schematic view for explaining the model dog with a portal systemic shunt.

As shown in FIG. 5, a PSS model dog D is an experimental model dog in which a portal vein 41 is ligated at a hepatic portal portion (a ligated portion 42), and a shunt blood vessel 45 is formed between the portal vein 41 and caudal vena cava 43 to artificially create the portal systemic shunt. In the PSS model dog, portal vein blood does not flow in a liver 40 thereof but flows in an aorta. Thus, an amount of blood which flows in the liver 40 is not sufficient. In other words, a blood vessel which supplies a nutrient to the liver 40 is a hepatic artery only (not shown), and a nutrient absorbed from an intestine 46 does not directly flow into the liver 40. The liver 40 of the PSS model dog is poorly developed and is retracted, which remarkably lowers a hepatic function thereof. It is to be noted that a congenital PSS is a relatively common disease observed in dogs.

A commercially available food formulated for the liver (Waltham (registered trademark) liver support (dry type) supplied by Master Foods Limited hereinafter also referred to as a formula meal B) is given to the test dogs 1 to 5 twice a day for 7 straight days from one week before a start of the preliminary study to one day before the start of the preliminary study.

### <Administered Substances>

A food formulated for the liver (hereinafter referred to as a formula meal A) having a composition shown in Table 18 which includes the powdered health food of Example 1 and the aforementioned formula meal B was given to the test dogs 1 to 5.

The formula meal A was formulated by mixing the powdered health food of Example 1, cooked rice (rice, paddy rice, white rice, food number: 01088), and young chicken meat (breast tender, raw, food number: 11227).

Table 18 shows food names, mixed amounts (amounts to be administered), contents of the amino acids (BCAA, AAA), and the Fischer ratios contained in the formula meal A.

TABLE 18

| | | | | Dried | Admin | | | Phenyl- | | | |
|---|---|---|---|---|---|---|---|---|---|---|---|
| | Food | | Mass | ratio | amt | Isoleucine | Leucine | alanine | Tyrosine | Valine | Fischer |
| | number | Food name | (g) | (%) | (g) | (mg) | (mg) | (mg) | (mg) | (mg) | ratio |
| Powdered | 06212 | Carrot | 20 | 11.2 | 2.24 | 3.4 | 4.6 | 3.4 | 2.0 | 4.6 | |
| healthy | 06263 | Broccoli | 40 | 8.8 | 3.52 | 57.6 | 96.0 | 60.4 | 41.2 | 82.4 | |
| food | 06048 | Western pumpkin | 30 | 23.0 | 6.90 | 18.9 | 30.0 | 16.2 | 11.7 | 21.6 | |
| | 08013 | Dried shiitake mushroom | 1 | — | 1 | 6.17 | 9.88 | 6.17 | 3.39 | 7.41 | |
| | 02034 | Potato starch | 50 | — | 50 | 0 | 0 | 0 | 0 | 0 | |
| | 03015 | Powder candy | 10 | — | 10 | 0 | 0 | 0 | 0 | 0 | |
| Others | 01088 | Rice | 100 | — | 100 | 105.2 | 210.0 | 138.1 | 105.2 | 159.0 | |
| | 11227 | Young chicken meat | 70 | — | 70 | 823.9 | 1365.0 | 669.2 | 566.3 | 849.8 | |

| | | | | | | | | | | |
|---|---|---|---|---|---|---|---|---|---|---|
| Total | Powdered healthy food | 91 | — | 73.66 | 86.07 | 140.48 | 86.17 | 58.29 | 116.01 | 3.22 |
| | Total administered substances | 321 | — | 243.66 | 1015.17 | 1715.48 | 893.47 | 729.79 | 1124.81 | 3.22 |

The amount to be administered shown in Table 18 is an amount administered to a dog having a body weight of 10 kg per day. Depending on body weights of the test dogs 1 to 5 (8 kg, 9 kg or 15 kg), 0.8 times, 0.9 times or 1.5 times of the amount to be administered shown in Table 18 were given to the test dogs 1 to 5. It is to be noted that, even if the amount to be administered is changed, the Fischer ratio which is the molar ratio of BCAA to AAA contained in the formula food A is not changed. This means that all of the test dogs ingested the formula meal A having the same Fischer ratio of 3.14 (total administered substances) per day.

The amounts of the formula meal A administered to the test dogs 1 to 5 per day are shown in Table 19.

TABLE 19

| | | | Admin amt | Test dog 1 | Test dog 2 | Test dog 3 | Test dog 4 | Test dog 5 |
|---|---|---|---|---|---|---|---|---|
| | | | per 10 kg of | Bodyweight | Bodyweight | Bodyweight | Bodyweight | Bodyweight |
| | Food | | bodyweight | 9 kg | 9 kg | 8 kg | 15 kg | 15 kg |
| | number | Food name | (g) | (g) | (g) | (g) | (g) | (g) |
| Powdered | 06212 | Carrot | 2.24 | 2.0 | 2.0 | 1.8 | 3.4 | 3.4 |
| healthy | 06263 | Broccoli | 3.52 | 3.2 | 3.2 | 2.8 | 5.3 | 5.3 |
| food | 06048 | Western pumpkin | 6.90 | 6.2 | 6.2 | 5.5 | 10.4 | 10.4 |
| | 08013 | Dried shiitake mushroom | 1 | 0.9 | 0.9 | 0.8 | 1.5 | 1.5 |
| | 02034 | Potato starch | 50 | 45 | 45 | 40 | 75 | 75 |
| | 03015 | Powder candy | 10 | 9 | 9 | 8 | 15 | 15 |
| Others | 01088 | Rice | 100 | 90 | 90 | 80 | 150 | 150 |
| | 11227 | Young chicken meat | 70 | 63 | 63 | 56 | 105 | 105 |

| | | | | | | | |
|---|---|---|---|---|---|---|---|
| Total | Powdered healthy food | 73.66 | 66.3 | 66.3 | 58.9 | 110.5 | 110.5 |
| | Total administered substances | 243.66 | 219.3 | 219.3 | 194.9 | 365.5 | 365.5 |

80 g of the formula meal B was given to each of the test dogs 1 to 3 twice a day at around 8:00 a.m. and 6:00 p.m. 120 g of the formula meal B was given to each of the test dogs 4 and 5 also twice a day at around 8:00 a.m. and 6:00 p.m. The Fischer ratio of the formula meal B was approximately 2.

### <Study Method>

### (Preliminary Study)

A preliminary study was performed from one week to one day before a start of administration test, for 7 consecutive days.

Changes in states of the test dogs 1 to 5 to which the formula meal B continuously given were observed. A veterinarian observed the changes in states including four items, namely, appetite, activity, nausea and appearance of feces at each meal using observation criteria as follows.

### Appetite

+: Eat everything within 5 minutes

+: Eat everything but take time, or eat almost everything but leave a little

−: Eat only one bite, or eat nothing at all

### Activity

+: Happy just seeing people and active

+: Not so happy just seeing people, but respond when called and show activity

−: Respond poorly even when called, and show no activity

### Nausea (Emesis)

+: Yes

−: No

### Appearance of Feces (Diarrhea)

+: Diarrhea

±: Soft feces

−: Normal feces

The items of the changes in states were evaluated based on scores. Each item of one test dog per meal (twice a day) is scored as one point. A total score of each item for one week is 70 points, which is calculated by [5 dogs]×[2 meals a day]×[7 days (one week)]. For example, if two test dogs eat everything within 5 minutes, another two test dogs eat everything but take time, and the other test dog eats nothing, at one meal on a day, evaluations of “+”, “±” and “−” get 2,2 and 1 points, respectively, in scores of the appetite at the meal.

Blood of the test dogs 1 to 5 was collected one day before the start of the administration test (at around 4:00 p.m. on a seventh day of the preliminary study). The collected blood was subjected to measurement of a plasma branched chain amino acid concentration, a plasma tyrosine concentration, a serum albumin concentration, a total serum protein concentration, a blood ammonia concentration, and a serum zinc concentration, according to a standard method.

### (Administration Study)

In the administration test, the formula meals were switched to observe changes in states and concentrations of the measured blood components. The formula meal A was given to the test dogs 1 to 5 in a first week (Days 1 to 7), a second week (Days 8 to 14), and fifth through eighth weeks (Days 29 to 56). And, the formula meal B was given to them in a third week (Days 15 to 21) and a fourth week (Days 22 to 28).

Half the amount to be administered per day (see Table 19) of the formula meal A was given to them at each meal twice a day (at around 8:00 a.m. and 6:00 p.m.). The amount to be administered (80 g or 120 g) of the formula meal B was given to them twice a day (at around 8:00 a.m. and 6:00 p.m.).

The changes in states (appetite, activity, nausea, and appearance of feces) in the test dogs 1 to 5 were observed at each meal using same observation criteria as those in the preliminary study.

Blood of the test dogs 1 to 5 was collected on a final day in each week (Days 7, 14, 21, 28, 35, 42 and 56). The collected blood was subjected to measurement of the plasma branched chain amino acid concentration, the plasma tyrosine concentration, the serum albumin concentration, the total serum protein concentration, the blood ammonia concentration, and the serum zinc concentration, according to a standard method.

### <Results and Observation>

Results of the administration test and the preliminary study are described next. In related drawings, “pre” represents results of the preliminary study, “1 W” represents results of the administration test in the first week, “2 W” represents results of the administration test in the second week, and similarly, “8 W” represents results of the administration test in the eighth week.

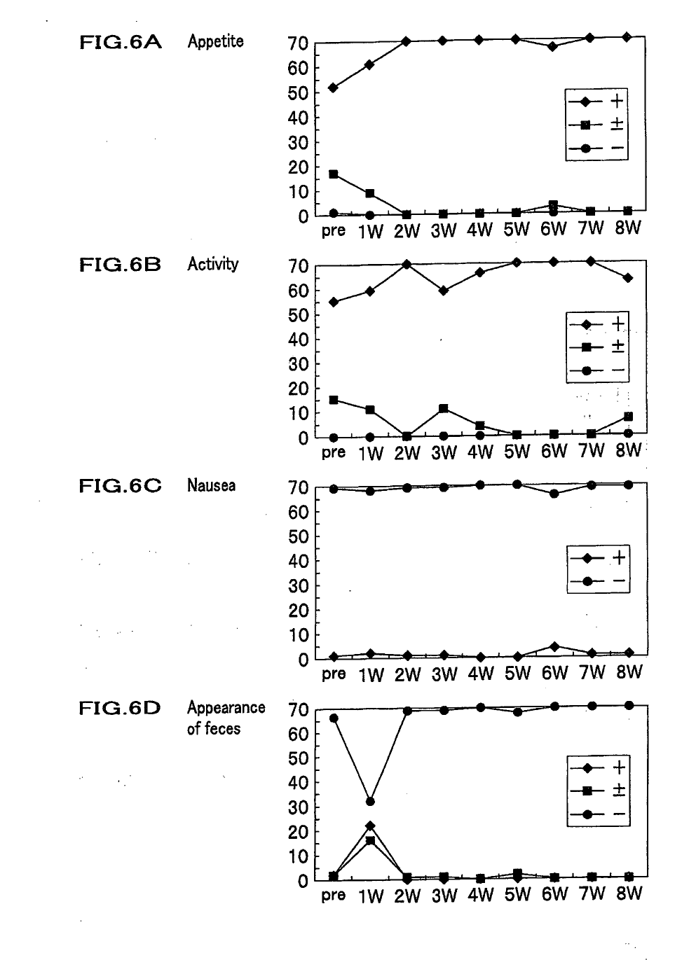

FIG. 6A to FIG. 6B are graphs showing the changes in the states in the test dogs.

FIG. 6A showing the appetite demonstrates that almost all of the test dogs ate everything within 5 minutes (sign “+”) after 2 weeks from the start of the administration test. The sign “±”, which indicates that the dog ate everything but took time or ate almost everything but left a little, got 17 points in the preliminary study; 9 points in the first week of the administration test; and mostly 0 points after 2 weeks from the start of the administration test.

The sign “−”, which indicates that the dog did not eat anything, got only 1 point in the preliminary study, and did not get any point during the administration test.

As shown in FIG. 6B, the activity (“+” indicating that the dog appears happy just seeing people) increased from the first week from when the formula meal A was given. In the second week, all of the test dogs had the activity (“+”) (70 points of “+”). The activity temporarily decreased in the third week in which the formula meal B was given, but increased again in the fourth week, and almost all of the dogs became active (“+”) from the fifth week from which the formula meal A was given. That is, the test dogs exhibited positive activity (happy just seeing people) during the administration period of the formula meal A.

No test dog that poorly responds even when called and showed no activity (“−”) was observed throughout the preliminary study and the administration test.

As shown in FIG. 6C, the presence of the nausea (emesis) was scarcely observed throughout the preliminary study and the administration test.

As shown in FIG. 6D of the appearance of feces, diarrhea (“+”) and soft feces (“±”) increased in the first week of the administration study. This may be caused by a temporary disordered digestion because the formula meal B was switched to the formula meal A. The test dogs were adapted to the formula meal A in and after the second week, and exhibited a stable normal state (“−”). The formula meals were switched also in the third week (from the formula meal A to the formula meal B) and in the fifth week (from the formula meal B to the formula meal A), but their effects were hardly observed.

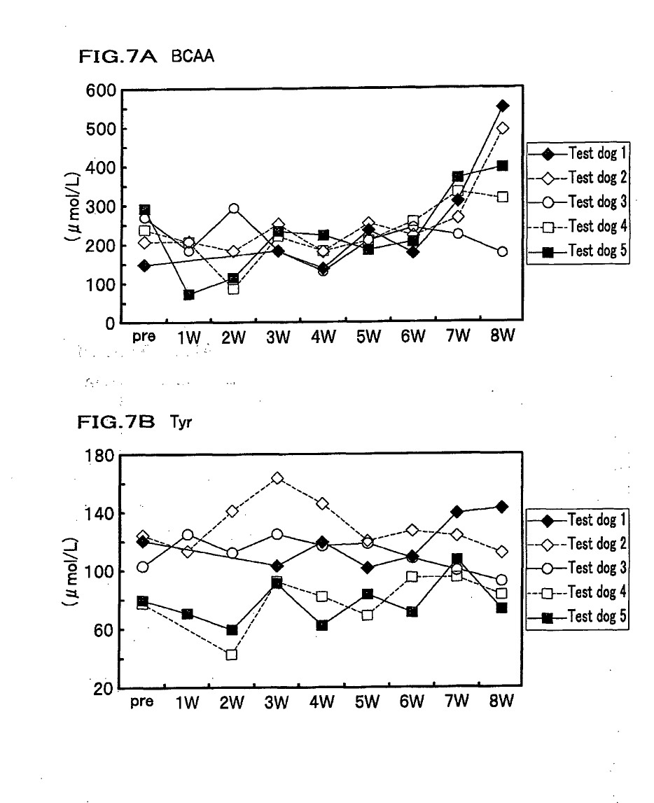

FIG. 7A is a graph showing changes in the branched chain amino acid concentration in plasma. FIG. 7B is a graph showing changes in the tyrosine concentration in plasma.

As shown in FIG. 7A, the BCAA concentrations in plasma of the test dogs 1 to 5 fluctuated throughout the administration test, but finally increased to about 1.3 to 3.7 times. Since the formula meal B had been continuously given to the test dogs 1 to 5 before the administration test started, administration of the formula meal A could contribute to an increase of the BCAA concentration in plasma.

In the test dog 3, however, the BCAA concentration finally decreased, but this may result from its high-level metabolic amount of BCAA.

As shown in FIG. 7B, the Tyr concentrations in plasma were temporarily increased or decreased throughout the administration test period, but, as a whole, did not change significantly, compared with the BCAA concentrations. The increased BCAA concentrations and the unchanged AAA (Tyr) concentrations may increase the Fischer ratio in blood, because, as described above, the Fischer ratio is a molar ratio of BCAA to AAA (BCAA/AAA).

A molar ratio of BCAA to tyrosine (BCAA/Tyr) is referred to as BTR and, to be precise, is different from the Fischer ratio (BCAA/AAA). The BTR is also an indicator of a lowered hepatic function like the Fischer ratio. As the BTR and the Fischer ratio are similar indicators, only the tyrosine concentration in plasma was measured in the administration test.

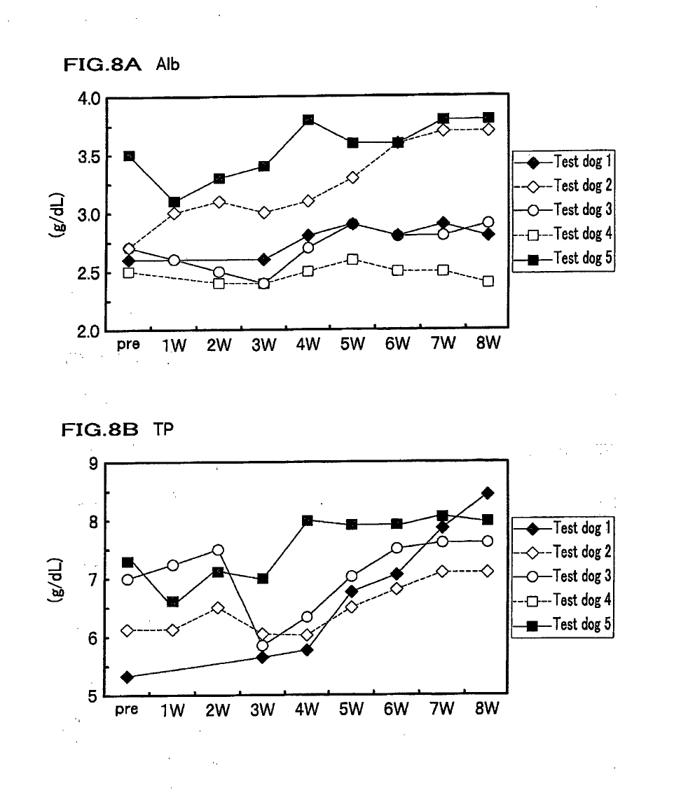

FIG. 8A is a graph showing changes in the albumin concentrations in serum. FIG. 8B is a graph showing changes in the total protein concentrations in serum.

As shown in FIG. 8A and FIG. 8B, both the albumin concentrations in serum and the total protein concentrations in serum exhibited an upward trend as a whole. As described above, since the formula meal B had been continuously given to the test dogs 1 to 5 before the administration test started, administration of the formula meal A could contribute to increases of the albumin concentration in serum and the total protein concentration in serum. That is, the formula meal A made it possible to improve hepatic functions to synthesize proteins of the test dogs as a whole.

The total protein concentrations in the test dog 4, however, exhibited unreliable values (largely exceeded a normal value range) and were not shown in FIG. 8B. Hence, the albumin concentrations in the test dog 4 may not be highly reliable.

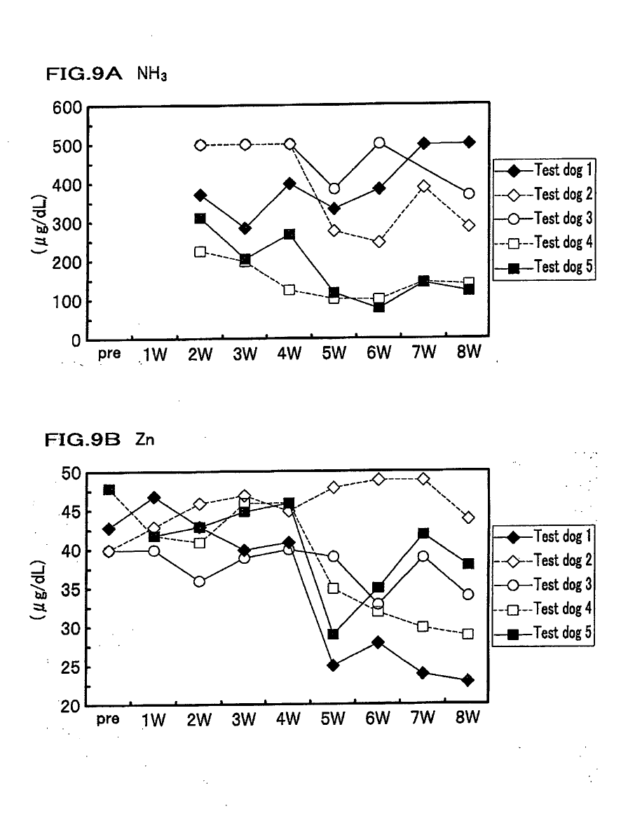

FIG. 9A is a graph showing changes in the ammonia concentrations in blood in the test dogs in the administration test. FIG. 9B is a graph showing changes in the zinc concentrations in serum.

In the preliminary study (pre) and the first week (1 W) in the administration test, the ammonia concentrations in blood in all of the test dogs exhibited values as high as more than 500 μg/dL (not shown). In and after the fifth week (5 w) in the administration test, however, those in the test dogs 2 to 4 exhibited a downward trend. This may result from an increased Fischer ratio in blood in the test dogs, which increased an amount of a glutamic acid generated from BCAA, to thereby increase an amount of ammonia metabolized in skeletal muscle thereof. The increased Fischer ratio may also improve a hepatic function thereof, thus increasing an amount of ammonia metabolized in a liver.

The ammonia concentration in the test dog 1 kept high. This may be because that the zinc concentration in serum in the test dog 1 decreased by half during the administration study. Zinc is required when ammonia is metabolized in a liver and skeletal muscle. The decreased zinc concentration in the test dog 1 may reduce the amount of ammonia metabolized of in the liver and the skeletal muscle.

From the above described results, the Fischer ratio in blood was improved by administering the formula meal A. This enhanced amounts of a synthesized protein and metabolized ammonia. Further, administration of the formula meal A improved or maintained activities of the test dogs. Therefore, the powdered health food according to the present invention improved hepatic functions of the test dogs.

The embodiments according to the present invention have been explained as aforementioned. However, the embodiments of the present invention are not limited to those explanations, and those skilled in the art ascertain the essential characteristics of the present invention and can make the various modifications and variations to the present invention to adapt it to various usages and conditions without departing from the spirit and scope of the claims.

1. A powdered health food comprising at least one selected from a group consisting of powders of a plurality of vegetables,
the powdered health food having a Fischer ratio which is a molar ratio of a branched chain amino acid to an aromatic amino acid each contained therein, of 2.1 or higher.

2. The powdered health food according to claim 1, further comprising at least one selected from a group consisting of powders of grain, potato, nuts and seeds, fruit, mushroom, and alga.

3. The powdered health food according to claim 2, wherein the grain and potato include processed products thereof.
